(19) United States
(12) Patent Application Publication
(10) Pub. No.: US 2009/0184187 A1
(43) Pub. Date: Jul. 23, 2009

(54) CONCRETE CRUSHER

(76) Inventor: Gerald Robinson, Burnaby (CA)

Correspondence Address: VERMETTE & CO., SUITE 320 - 1177 WEST HASTINGS STREET, VANCOUVER, BC, V6E2K3, CA

(21) Appl. No.: 12/016,806

(22) Filed: Jan. 18, 2008

(51) Int. Cl. B02C 13/26

(52) U.S. Cl. 241/69; 241/194; 241/275; 241/285.1

(57) ABSTRACT

A centrifugal impact crusher, having a housing, a rotor having a shaft journaled to the housing and a plurality of spaced apart slots in each side of the shaft, a plurality of hammers or cutters pivotally attached to one side of each slot by pins with the pins lying along two axes running parallel to the shaft, each of said hammers pivotal from a position proximate said shaft to a position in which it extends outwardly away from the shaft. A slotted table is located on another side of the rotor having spaced apart arms, the slots allowing the hammers to pass through without hitting the arms and an exit for allowing crushed material to escape from the housing.

### FIELD

The present invention relates to a centrifugal rock crusher for crushing and pulverizing raw material such as concrete, rock and brick.

### BACKGROUND

Known rock crushers have a rotor, with a central drive shaft having several flanges, a plurality of hammers pivotally mounted between the flanges on eccentric axles passing through these flanges parallel to the central drive shaft. In some embodiments, the inner walls of the stationary housing have an anvil-forming piece which, together with the hammers of the rotor, break up the raw material. In other embodiments, the interior walls are lined with a plurality of liners against which pieces of raw material impact. Material to be crushed is admitted from above into the impact chamber so that it falls onto and is impacted by the impeller blades. Material which is impacted by the impeller blades is flung against plates that line the housing. Repeated impacting of the material by the blades and the plates causes the crushing of the material. The energy to break the material is applied at high speed in the form of kinetic energy. Typical rotor speeds are in the range of 600 to 1,500 revolutions per minute. Operation at these high speeds causes certain problems including accelerated wear of breaker blades and plates, and the production of dust. The machine must be shut down frequently and the liners replaced. A common problem with such rock crushers is the severe abrasive action and wear which demands frequent down time and replacement, repair and/or adjustment. These problems may be reduced by operating at lower speeds. However, other problems arise by operation at low speeds such as the hammers getting stuck in the material being processed. Known crushers have hammers which are fixed to the rotating shaft so that upon impacting an immovable object the hammer either breaks or it jams the machine.

### SUMMARY OF THE INVENTION

According to the invention there is provided a centrifugal impact crusher or grinder having a housing, a rotor having a shaft journaled to the housing and a plurality of spaced apart slots in the shaft. A plurality of hammers or cutters are pivotally positioned in each slot by swivel pins with each of the hammers pivotal from a position proximate the shaft to a position in which the hammers extend outwardly away from the shaft and motor means for rotationally driving the rotor.

Preferably a slotted table is positioned on another side of the rotor having spaced apart arms, the slots of the table having a width which allows the hammers to pass through in close proximity to the table slot arms without hitting the arms and an exit for allowing crushed material to escape from the housing.

A hopper is located on one side of the rotor having spaced apart arms and inclined downwardly from an inlet towards the rotor, the hammers passing through spaces between the arms.

Preferably, the rotor has slots provided by a plurality of spaced apart discs.

Each arm of the table has an upwardly projecting pin on a top surface thereof to assist in fracturing material impacted by the hammers.

The rotor is coupled to a motor and rotates at speeds in the range of 100 RPM to 1,000 RPM.

The hammers are each pivotally attached to a disc at 0.7 to 0.8 of the radius of the slot.

A grate covers the exit to control the size of particles that can escape.

### BRIEF DESCRIPTION OF THE DRAWINGS

In the accompanying drawings, in which the preferred embodiment of the invention is shown by way of illustration:

FIG. 1 is perspective view of the rotor showing the spaced apart discs with pivotal hammers between the discs;

FIG. 2 is an end view of the rotor showing the attachment point of the hammers and the slotted tables;

FIG. 3 is a sectional view through the rotor showing the position of the hammers when the rotor's rate of rotation is slow;

FIG. 4 is a perspective view through the inlet showing the discs and hammers between a slotted hopper and a slotted table and the hammers extended;

FIG. 5 is a perspective view as in FIG. 4 except that the set of hammers closest to the inlet are retracted except for one; and

FIG. 6 is a perspective view of a modification to the rotor in which the rotor has been removed from the housing and a shield and attachment coupling to the rotor has been provided so that the rotor can be mounted onto an end of an articulatling arm of a piece of heavy equipment such as a tractor or bulldozer.

### DETAILED DESCRIPTION WITH REFERENCE TO THE DRAWINGS

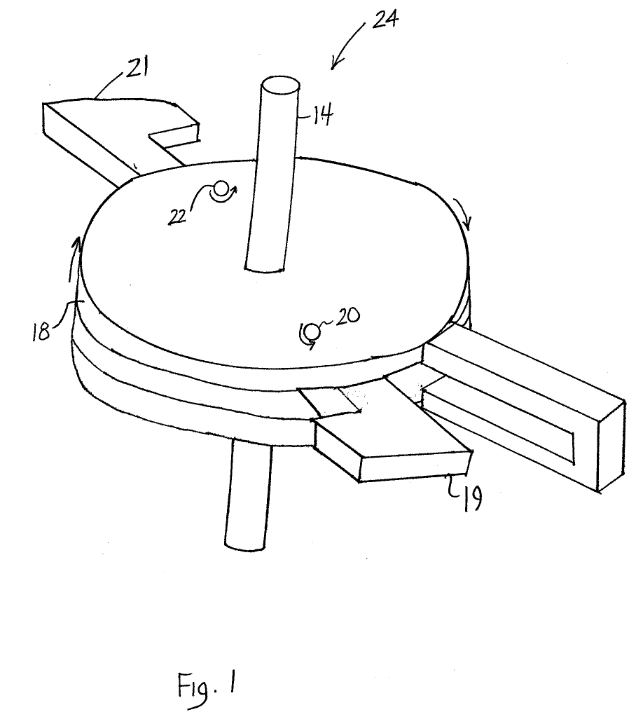

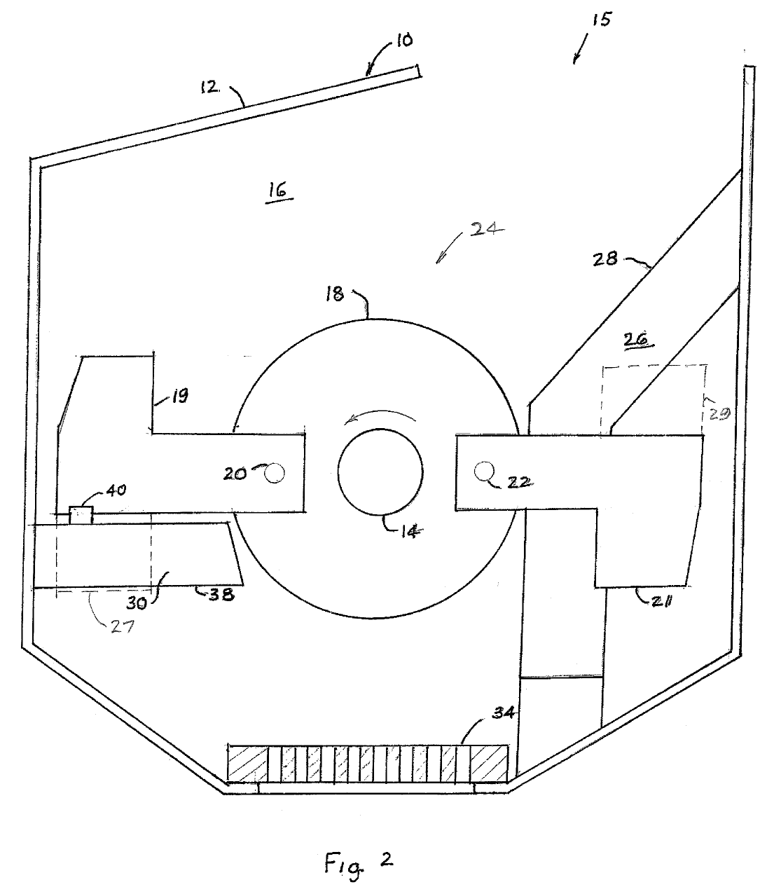

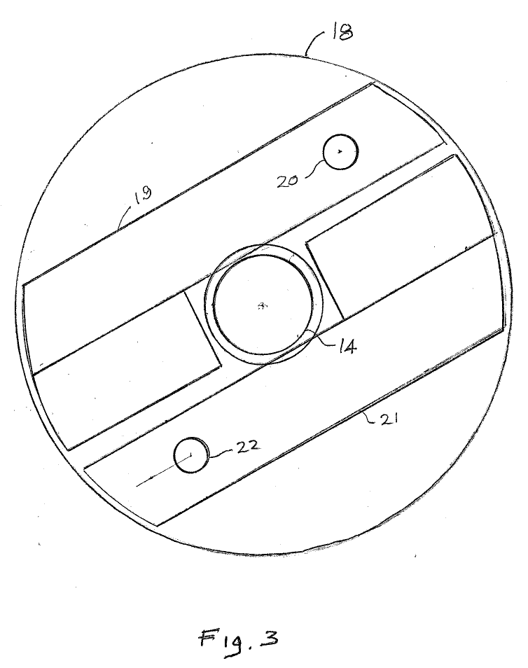

Referring to FIGS. 1 and 2 the rock crusher 10 consists of a housing 12 and a central drive shaft 14 journaled to ends of the housing interior 16. A plurality of heavy discs 18 are attached to the shaft 14 at regularly spaced apart locations. The heavy discs 18 act as a flywheel, developing inertia and absorbing shock. Half of a set of hammers 19 are pivotally attached to the discs 18 along a first swivel pin 20 located at a radius of 0.7 to 0.8 of the radius of the discs 18 and hammer 21 are pivotally attached to the discs 18 along a second swivel pin 22 diametrically opposite to the first swivel pin 20 (see FIG. 2). As the shaft 14 rotates the hammers 19 and 21 experience centrifugal force and begin to rotate outwardly into the space external to the discs 18. The shaft, hammers and discs all make up the rotor 24. Having a series of oppositely disposed hammers balances the weight of the hammers 19 and 21 about the axis of rotation of the discs 18. Referring to FIG. 3 hammers 19 and 21 are shown in the rest position in which the rotor 24 is either at rest or rotates only slowly. In this position, the hammers 19 and 21 are parallel and lie adjacent to the shaft 14. As the speed of rotation of shaft 14 increases, the hammers 19 and 21 rotate outwardly relative to the discs 18 about pins 20 and 22 as described above. Generally the heavier the hammers, the more inertial they carry for a given speed of rotation and the greater the impact they produce. Weights 27 and 29 can be added to the individual hammers 19 and 21 either by welding on pieces of steel or bolting them onto the existing hammers as shown in FIG. 2.

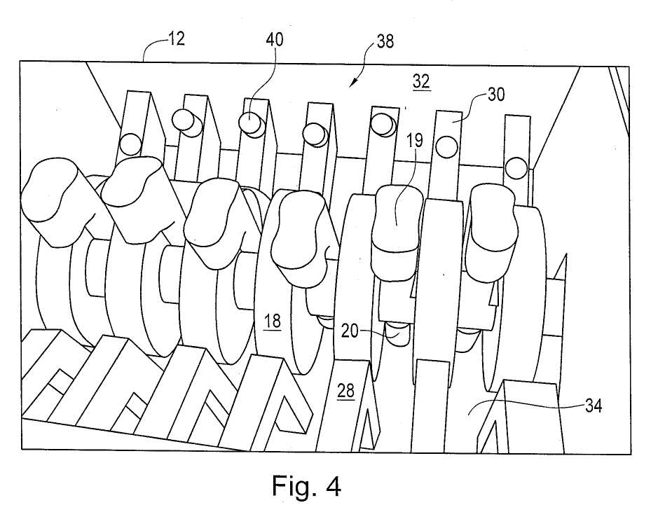

On one side of the rotor 24 there is a hopper 26 which has a plurality of spaced apart arms 28 with spaces in between that line up with the hammers 19 and 21. Arms 28 are inclined downwardly towards the discs 18, stopping short of contact with the discs 18 and leaving a small gap between the arms 28 and the discs 18. On the other side of the discs 18 there is a slotted table 38 having a plurality of spaced apart horizontally disposed arms 30 extending from an interior wall surface 32 of the housing 12 (see FIG. 4) to the discs 18. The separation between arms 30 is slightly greater than the thickness of the hammers 19 and 21. Each arm 30 has a pin 40 projecting upwardly and is in a different position along the arm from its adjacent arms 30. At the bottom of the housing 12 there is a grate 34 that prevents material that has not been pulverized from exiting.

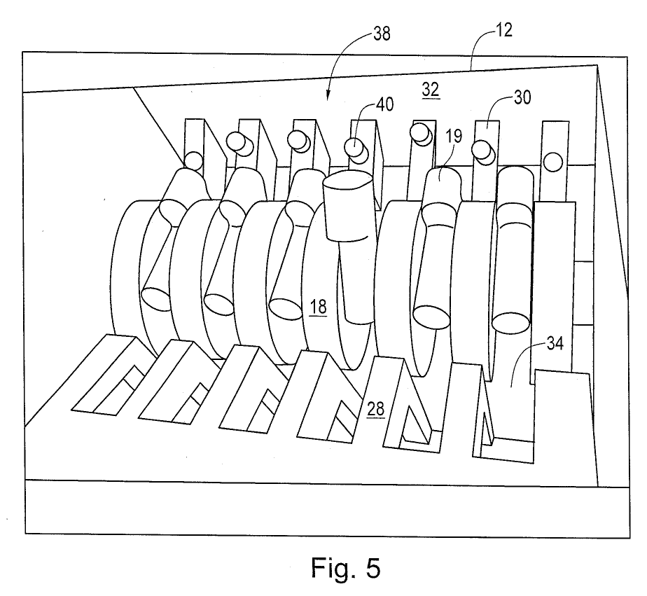

As seen in FIGS. 4 and 5, the hammers 19 and 21 extend out fully by rotating about their respective pin axes 20 and 22. The hammers 19 and 21 pass though the space between the arms of the table 30 and hopper 26 in close proximity to the arms.

As raw material such as broken pieces of concrete are put into the inlet 15, the rotation of the discs causes it to move onto the slotted table 38. The next hammer arrives and hits the material. If the material rests on one of the upwardly extending pins 40 it is readily fractured as there is no tendency for the material to lie flat against the table arms where the table 38 would absorb a good deal of the impact. Once fractured the pieces fall down onto a grate 34 and, if they are small enough, through the grate 34. After each hammer 19 impacts the raw material, it then pivots back into the space between the discs 18 on the shaft 14 clearing the way for the next hammer 21 to make the next strike. Thus, each hammer 19 and 21 has the opportunity to hit the material several times without jamming or slowing the rotation of the rotating disc 18. The disc 18 can be spun freely at a slow speed with very little power as the hammers 19 and 21 are resting in the down position proximate the shaft 14 Only when the rotation of the disc 18 is increased will they begin to pivot out from between the discs 18 automatically and begin impacting the raw material. As each hammer impacts the raw material, it then folds back into the space between the discs on the shaft 14 clearing the way for its twin to make the next strike. Allowing the hammers to pivot back between the discs 18 also prevents the rotor from being blocked upon a hammer contacting resistant raw material.

The raw material can be rock, concrete, wood, and other material. The resulting aggregate can be reused as fill, base material added to new concrete mixtures and as drain rock in housing or other construction.

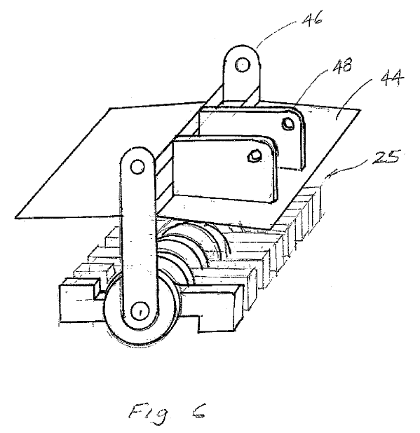

In an alternative embodiment of the invention shown in FIG. 6 the rotor 24 is removed from the housing 12 and has attached parts for coupling to the end of the articulating arm of an excavator (not shown) to form a grinder 25. Arms 46 couple to the end of the articulating arm with pins in a way known in the art, and hydraulic cylinders coupled to brackets 48. A hydraulic motor (not shown) is coupled to the shaft 14 and causes the shaft 14 to rotate. When the articulating arm causes the grinder 25 to contact a stump or the like, the rotating hammers cause the stump to disintegrate.

The hammers 19 and 21 can be replaced by cutters with sharpened contact surfaces. The weight of the hammer or cutter in conjunction with its speed of rotation will determine its impact. Chips of wood are removed as the hammer hits the stumps or root balls.

If a rock is buried in a root ball it could cause damage to normal cutters, but this design allows the hammer or cutter to retract into its protective disc slots, to prevent breakage or considerable damage.

The spinning discs provide an inertia which maintains the speed of rotation of the hammers as they impact the material being broken.

It will be obvious to persons skilled in the art that the number of hammers per disc can be three or even four provided the dimensions of the slots or discs are increased.

Accordingly while this invention has been described with reference to illustrative embodiments, this description is not intended to be construed in a limiting sense. Various modifications of the illustrative embodiment will be apparent to those skilled in the art upon reference to this description. It is therefore contemplated that appended claims will cover any such modifications or embodiments as fall within the scope of the invention.

I claim:

1. A centrifugal impact crusher or grinder, comprising:
(a) a housing;
(b) a rotor having a shaft journaled to said housing and a plurality of spaced apart slots in said shaft, a plurality of hammers or cutters pivotally positioned in each slot by swivel pins with each of said hammers pivotal from a position proximate said shaft to a position in which the hammers extend outwardly away from the shaft; and
(c) motor means for rotationally driving said rotor.

2. A crusher or grinder according to claim 1, including:
(d) slotted table on another side of said rotor having spaced apart arms, the slots having a width which allows said hammers to pass through in close proximity to said table slot arms without hitting said arms; and
(e) an exit for allowing crushed material to escape from said housing.

3. A crusher or grinder according to claim 1, wherein said rotor has a shaft journaled to said housing and a plurality of spaced apart discs affixed to said shaft, a pair of hammers or cutters pivotally attached to each disc by two diametrically opposed pins with the pins lying along two axes running parallel to said shaft, each of said hammers pivotal from a position proximate said shaft to a position in which it extends outwardly away from the shaft;

4. A crusher or grinder according to claim 1 or 2, including a hopper on one side of said rotor having spaced apart arms and inclined downwardly from an inlet towards said rotor, said hammers passing through space between said arms.

5. A crusher or grinder according to claim 1, wherein each arm of said table has an upwardly projecting pin on a top surface thereof to assist in fracturing material impacted by said hammers.

6. A crusher or grinder according to claim 1, wherein said discs are sufficiently heavy so that they act as a flywheel, carrying substantial inertia compared with said shaft and discs and absorbing shock.

7. A crusher or grinder according to claim 1, wherein a weight of each of said hammers may be increased by adding additional pieces of hammer material to said hammers.

8. A crusher or grinder according to claim 1, wherein said rotor is coupled to a motor and rotates at speeds in the range of 100 RPM to 1,000 RPM.

9. A crusher or grinder according to claim 1, wherein said hammers are each pivotally attached to a disc at 0.7 to 0.8 of the radius of said disc.

10. A crusher or grinder according to claim 1, including a grate over said exit to control the size of particles that can escape.

11. A crusher or grinder according to claim 1, including a shield mounted on an operator's side of said rotor to said housing to prevent wood chips and the like from impacting on a user.

12. A crusher or grinder according to claim 11, including mounting brackets operative to couple an end of an articulating arm of a piece of heavy equipment to said brackets and enable said piece of heavy equipment to control movement and operation of said crusher or grinder
